(19) United States
(12) Patent Application Publication
(10) Pub. No.: US 2006/0104194 A1
(43) Pub. Date: May 18, 2006

(54) Optical information-recording medium

(75) Inventors: Hironori Ota, Ibaraki-shi (JP); Yoshiyuki Nagataki, Ibaraki-shi (JP); Toshinori Sugiyama, Ibaraki-shi (JP)

Correspondence Address: OLIFF & BERRIDGE, PLC, P.O. BOX 19928, ALEXANDRIA, VA, 22320, US

(73) Assignee: HITACHI MAXELL, LTD., Ibaraki-shi (JP)

(21) Appl. No.: 11/272,976

(22) Filed: Nov. 15, 2005

(30) Foreign Application Priority Data
Nov. 17, 2004 (JP) 2004-333076

(51) Int. Cl. G11B 7/24

(52) U.S. Cl. 369/275.4

(57) ABSTRACT

An optical information-recording medium, which is provided with a substrate and a light-absorbing layer formed of a dye material on the substrate, includes a user information area in which a concave/convex pattern including spiral-shaped or concentric grooves are formed, and BCA which is provided on an inner circumferential side of the user information area and in which information is recorded with a bar code, wherein a concave/convex pattern, which is different from the concave/convex pattern in the user information area, is formed in BCA. With this construction, an optical information-recording medium, on which BCA information is reproduced without performing any tracking, is provided, wherein a BCA reproduced signal having a satisfactory signal quality is obtained from BCA.

### BACKGROUND OF THE INVENTION

1. Field of the Invention

The present invention relates to an optical information-recording medium. In particular, the present invention relates to an optical information-recording medium on which management information is recorded with a bar code.

2. Description of the Related Art

The optical information-recording medium such as DVD-ROM includes a medium having an area which is disposed at the innermost circumference thereof and from which information can be read without performing any tracking servo control. Those known as such an area include BCA (Burst Cutting Area) in which information is recorded with a bar code (see, for example, Japanese Patent Application Laid-open Nos. 10-188361 and 6-203412). In the case of Japanese Patent Application Laid-open No. 10-188361, the management information is recorded in BCA which is disposed outside the user information area, in accordance with a modulation system which is different from that for the user information area in order to manage the user information such as the information about the program, the data, and the application written in the user information area and/or in order to protect the copyright thereof.

As disclosed in Japanese Patent Application Laid-open No. 6-203412, BCA is formed at the stage of producing the optical information-recording medium. For example, in the case of DVD-ROM, BCA is formed by removing the reflective film by means of the YAG laser. The identification information of the individual optical information-recording medium such as the serial number is recorded in BCA, and BCA is used to protect the copyright as well. In the case of DVD-R which is a write-once type optical information-recording medium, a problem arises such that the recording layer and the reflective film are subjected to the exfoliation, if the reflective film is removed by means of the YAG laser in the same manner as in DVD-ROM. Therefore, in the case of DVD-R, the BCA information is recorded by forming a bar code at a groove portion in a control area by using an exclusive or special purpose BCA writer.

The conventional DVD-R has a groove which is formed in BCA and which has the same shape as that of the user information area. The information of BCA is reproduced while performing the tracking with the groove.

The inventors provided BCA at the innermost circumference of a disk in the same manner as in the conventional technique for HD DVD-R based on the use of a dye material for a recording layer of HD DVD as the next generation optical disk to reproduce BCA information without performing any tracking control for BCA (with performing only the focus control). As a result, it was not possible to correctly reproduce the BCA information.

The present invention has been made in order to solve the problem as described above, an object of which is to provide an optical information-recording medium which makes it possible to reproduce the BCA information while providing a satisfactory signal quality, for example, even in the case of the optical information-recording medium such as HD DVD as described above on which the BCA information is reproduced without performing any tracking control.

### SUMMARY OF THE INVENTION

According to an aspect of the present invention, there is provided an optical information-recording medium provided with a substrate and a light-absorbing layer formed of a dye material on the substrate, the optical information-recording medium comprising:

a user information area in which a concave/convex pattern including spiral-shaped or concentric grooves is formed; and

BCA which is provided on an inner circumferential side of the user information area and in which information is recorded with a bar code, wherein:

a concave/convex pattern, which is different from the concave/convex pattern formed in the user information area, is formed in BCA.

The inventors firstly formed BCA with a mirror section on HD DVD including a dye material used for the light-absorbing layer (recording layer) to record and reproduce BCA information. However, it was impossible to obtain any BCA reproduced signal having a sufficient amplitude, and it was impossible to correctly reproduce the BCA information, for the following reason. That is, when the recording layer is formed so that the film thickness of the recording layer is optimum at the grooves of the user information area, then the dye material does not remain sufficiently on BCA because BCA is formed with the mirror section, and the film thickness of the recording layer on BCA becomes thin. When the dye material is used for the recording layer, then it is approved that the optimum film thickness range of the recording layer exists in order to obtain the sufficient recording and reproduction characteristic, and hence the sufficient recording and reproduction characteristic is not obtained when the film thickness is excessively thicker or thinner than the optimum film thickness range. Therefore, it has been revealed that the BCA information cannot be reproduced correctly when BCA is formed with the mirror section, because the recording layer, which has the film thickness sufficient to reproduce the BCA information, is not formed on BCA. In view of the above, when the film thickness of the recording layer on BCA is made thick so that the BCA information can be sufficiently reproduced, then the film thickness of the recording layer on the grooves in the user information area becomes too thick in this case, and the recording characteristic of the user information area is deteriorated.

Further, the inventors have made the trial as follows in order to form a recording layer having a thickness most suitable to reproduce information on both of BCA and the user information area. That is, the same grooves as the grooves in the user information area is formed in BCA in the same manner as in the conventional DVD-R to record and reproduce the BCA information. However, in this case, the amplitude fluctuation of the BCA reproduced signal is increased, and the BCA information cannot be reproduced correctly, for the following reason. That is, if the BCA information is reproduced without performing any tracking control as in HD DVD, the reproducing light beam is radiated to traverse the groove section and the land section of BCA due to any eccentricity of the disk, i.e., the reproducing light beam is radiated to traverse the area in which the film thickness of the recording layer is thick and the area in which the film thickness of the recording layer is thin. Therefore, the amplitude of the reproduced signal is fluctuated (cross-track signal is generated). More specifically, the amplitude of the reproduced signal is increased at the groove portion of BCA, because the film thickness of the recording layer is sufficiently thick. However, any reproduced signal having a sufficient amplitude is not obtained at the land portion, because the film thickness of the recording layer is thin. As a result, the amplitude of the recording signal from BCA is fluctuated.

The present invention has been made in order to solve the problem as described above. In the case of the optical information-recording medium of the present invention, the concave/convex pattern, which is different from the concave/convex pattern in the user information area, is formed in BCA so that the recording layer having the sufficient film thickness can be formed in BCA without affecting the recording and reproduction characteristic of the user information area, and the reproduced signal, which scarcely undergoes the amplitude fluctuation, is obtained from BCA even when no tracking control is performed. The phrase “different concave/convex pattern” referred to in this specification means the following. That is, the meaning is not limited to only the fact that the shape (for example, the shapes of the groove and the pit) of the concave/convex pattern differs. The meaning also includes the fact that the concave/convex pattern has any different size (for example, the track pitch and the groove width) even when the shape is identical.

In the optical information-recording medium of the present invention, it is preferable that the following relationship holds between a track pitch TP of the concave/convex pattern of BCA and a track pitch TPy of the concave/convex pattern in the user information area:
TP<TPy (1)

In the optical information-recording medium of the present invention, it is preferable that the concave/convex pattern of BCA includes grooves, and the following relationship holds among a width LW1 between the grooves of BCA, a wavelength k of a reproducing light beam and a numerical aperture NA of an objective lens to be used for reproduction on the optical information-recording medium:
(LW1×NA)/λ≦0.3 (2)

In the optical information-recording medium of the present invention, it is preferable that the concave/convex pattern of BCA includes emboss pit arrays, and the following relationship holds among a width LW2 between the emboss pit arrays of BCA, a wavelength λ of a reproducing light beam and a numerical aperture NA of an objective lens to be used for reproduction on the optical information-recording medium:
(LW2×NA)/λ≦0.3 (3)

In the optical information-recording medium of the present invention, it is preferable that the concave/convex pattern of BCA includes grooves and emboss pit arrays formed between the grooves, and the following relationship holds among a wider width LW3 of widths between an emboss pit array of the emboss pit arrays and grooves of the grooves disposed on both sides the emboss pit array, a wavelength k of a reproducing light beam and a numerical aperture NA of an objective lens to be used for reproduction on the optical information-recording medium:
(LW3×NA)/λ≦0.3 (4)

When the concave/convex pattern is formed in BCA to satisfy any one of the expressions (1) to (4) described above, then the dye material remains at the emboss pit portion and the groove portion of BCA, and the film thickness of the recording layer on BCA is sufficiently thick, even when the recording layer is coated and formed, for example, by the spin coat method to have such a film thickness that the recording characteristic of the user information area is optimum. When the concave/convex pattern is formed in BCA to satisfy any one of the expressions (1) to (4) described above, then the area of the land portion other than the groove portion and/or the emboss pit portion of BCA is smaller than the optical resolution λ/(2·NA) of the optical disk drive to be used for the recording and reproduction, and the area has a completely indistinguishable size. In this situation, when the reproducing light beam is radiated on BCA without performing the tracking, the reproducing light beam is radiated to traverse the groove portion and the land portion of BCA due to the eccentricity of the medium. However, the area of the land portion is smaller than the optical resolution. Therefore, the reproduced signal is obtained from BCA, the reproduced signal being formed by averaging the reproduced signal of the land portion at which the signal amplitude is scarcely obtained and the reproduced signal of the groove portion and the emboss pit portion at which the sufficient signal amplitude is obtained. As a result, it is possible to suppress the amplitude fluctuation of the BCA reproduced signal.

When the concave/convex pattern is formed in BCA to satisfy any one of the expressions (1) to (4) described above, then the following relationship holds between a minimum amplitude Imin of a reproduced signal of BCA and an amplitude CT of a cross-track signal, and thus it is possible to reproduce the BCA information with a satisfactory signal quality:
Imin>CT.
In the case of the optical information-recording medium of the present invention, the concave/convex pattern is also formed in BCA. Therefore, the reproduced signal level, which is obtained from the groove and the emboss pit array when the BCA information is reproduced, is slightly different from the reproduced signal level which is obtained form the land portion other than the areas as described above. The influence of the cross-track signal is more or less exerted. However, according to a verifying experiment performed by the inventors, when the concave/convex pattern of BCA is formed to satisfy any one of the expressions (1) to (4), the minimum amplitude Imin of the reproduced signal is larger than the amplitude CT of the cross-track signal, even when the influence of the cross-track signal is more or less exerted when the information of BCA is reproduced without performing the tracking. Therefore, it is possible to reproduce the BCA information more correctly. The phrase “amplitude of the cross-track signal” referred to in this specification is the larger fluctuation amount of the fluctuation amount of the non-recorded level of the reproduced signal obtained from BCA (signal level obtained from the non-recorded portion of BCA) and the fluctuation amount of the recorded level (signal level obtained from the recorded portion of BCA).

In the optical information-recording medium of the present invention, when the concave/convex pattern is formed in BCA to satisfy any one of the expressions (1) to (4), the following relationship holds between a higher reflectance RH and a lower reflectance RL of reflectances of a recorded portion and a non-recorded portion of BCA, even when the information of BCA is reproduced without performing any tracking:
(RH−RL)/RH≧0.2.
That is, the modulation factor of the reproduced signal of BCA is not less than 20%, and it is possible to obtain the BCA reproduced signal having the satisfactory signal quality.

In the optical information-recording medium of the present invention, it is preferable that the following relationship holds among a track pitch TP of BCA, a wavelength λ of a reproducing light beam and a numerical aperture NA of an objective lens to be used for reproduction on the optical information-recording medium:
(TP×NA)/λ≦0.6 (5)
It is more preferable that the following relationship holds:
0.45≦(TP×NA)/λ≦0.6 (6)

The inventors have found out the fact that when the concave/convex pattern of BCA is formed with the grooves in the optical information-recording medium of the present invention, the following reproduced signal characteristic is obtained by forming the grooves in BCA to satisfy the expression (2) and the expression (5) or (6). When the information of BCA is reproduced by radiating the reproducing light beam onto BCA without performing any tracking, a first amplitude of a reproduced signal is obtained when a spot center of the reproducing light beam is positioned at a center of a groove of the grooves, and a second amplitude of a reproduced signal is obtained when the spot center of the reproducing light beam is positioned at a center between the grooves, wherein one of the first and second amplitudes is not less than the other of the first and second amplitudes, and a ratio between one of the first and second amplitudes and the other of the first and second amplitudes is not more than 1.4. That is, when the grooves are formed in BCA to satisfy the expression (2) and the expression (5) or (6), it is possible to obtain, from BCA, the reproduced signal in which the amplitude fluctuation is extremely small.

The phrase “amplitude of the reproduced signal,, obtained from BCA referred to in this specification is the difference between the non-recorded level of the BCA reproduced signal (signal level obtained from the non-recorded portion of BCA) and the recorded level (signal level obtained from the recorded portion of BCA). The relationship of relative magnitude between the amplitude of the reproduced signal obtained when the spot center of the reproducing light beam is positioned at the center of the groove and the amplitude of the reproduced signal obtained when the spot center of the reproducing light beam is positioned at the center between the grooves differs depending on the material for forming the recording layer (light-absorbing layer).

When the concave/convex pattern of BCA is formed with the emboss pit arrays in the optical information-recording medium of the present invention, the inventors have found out the fact that the following reproduced signal characteristic is obtained by forming the emboss pit arrays in BCA to satisfy the expression (3) and the expression (5) or (6). When the reproducing light beam is radiated onto BCA to reproduce the information of BCA without performing any tracking, a third amplitude of a reproduced signal is obtained when a spot center of the reproducing light beam is positioned at a center of an emboss pit array of the emboss pit arrays, and a fourth amplitude of a reproduced signal is obtained when the spot center of the reproducing light beam is positioned at a center between the emboss pit arrays, wherein one of the third and fourth amplitudes is not less than the other of the third and fourth amplitudes, and a ratio between one of the third and fourth amplitudes and the other of the third and fourth amplitudes is not more than 1.4. That is, when the emboss pit arrays are formed in BCA to satisfy the expression (3) and the expression (5) or (6), it is possible to obtain, from BCA, the reproduced signal in which the amplitude fluctuation is extremely small.

When the concave/convex pattern of BCA is formed with the grooves and the emboss pit arrays formed between the grooves in the optical information-recording medium of the present invention, the inventors have found out the fact that the following reproduced signal characteristic is obtained by forming the emboss pit arrays in BCA to satisfy the expression (4) and the expression (5) or (6). When the information of BCA is reproduced by radiating the reproducing light beam onto BCA without performing any tracking, a fifth amplitude of a reproduced signal is obtained when a spot center of the reproducing light beam is positioned at a center of a groove of the grooves, and a sixth amplitude of a reproduced signal is obtained when the spot center of the reproducing light beam is positioned at a center between the groove and an emboss pit array of the emboss pit arrays, wherein one of the fifth and sixth amplitudes is not less than the other of the fifth and sixth amplitudes, and a ratio between one of the fifth and sixth amplitudes and the other of the fifth and sixth amplitudes is not more than 1.4. That is, when the grooves and the emboss pit arrays are formed in BCA to satisfy the expression (4) and the expression (5) or (6), it is possible to obtain, from BCA, the reproduced signal in which the amplitude fluctuation is extremely small.

In the optical information-recording medium of the present invention, it is preferable to form the concave/convex pattern of BCA so that any one of the expressions (2) to (4) and the expression (1) (feature of the track pitch TP of BCA narrower than the track pitch TPy of the user information area) simultaneously hold. However, the present invention is not limited thereto. On condition that the concave/convex pattern of BCA is formed with the shape to satisfy any one of the expressions (2) to (4), it is also allowable that the track pitch TP of BCA is the same as the track pitch TPy of the user information area. It is also allowable that the track pitch TP of BCA is larger than the track pitch TPy of the user information area to some extent. The inventors have confirmed, by a verifying experiment, the fact that the reproduced signal, in which the amplitude fluctuation is extremely small, is obtained from BCA even in the case of the situation as described above.

In the optical information-recording medium of the present invention, it is preferable that the information of the user information area is recorded and reproduced with a blue laser.

According to the optical information-recording medium of the present invention, the concave/convex pattern of BCA is formed to have the shape which satisfies any one of the expressions (1) to (4), while the concave/convex pattern of BCA is different from the concave/convex pattern formed in the user information area. Therefore, the recording layer, which has the film thickness of such an extent that the BCA reproduced signal is sufficiently obtained, can be formed on BCA. Further, even when the BCA information is reproduced without performing any tracking control, the minimum amplitude value of the BCA reproduced signal can be made larger than the amplitude value of the cross-track signal (amplitude fluctuation can be suppressed). Thus, it is possible to reproduce the BCA information with the satisfactory signal quality.

### BRIEF DESCRIPTION OF THE DRAWINGS

FIG. 1 shows a schematic plan view illustrating an embodiment of an optical information-recording medium of the present invention.

FIG. 2 shows a schematic arrangement of the substrate shape in BCA, a management information area, and a user information area of the optical information-recording medium of the present invention.

FIG. 3 illustrates the shape of the concave/convex pattern of BCA.

FIG. 4 show the positional relationship between the concave/convex pattern and the reproducing beam spot when the reproducing light beam is radiated onto BCA.

FIG. 5 shows a schematic sectional view illustrating the embodiment of the optical information-recording medium of the present invention.

FIG. 6 shows a schematic arrangement illustrating a cutting apparatus used when the optical information-recording medium of the present invention is manufactured.

FIG. 7 shows photographs of reproduced signal waveforms obtained from BCA's of optical information-recording media manufactured in Example 1 and Comparative Example 1.

FIG. 8 shows the relationship between the modulation factor and LW1, LW2, or LW3 in relation to optical information-recording media manufactured in Examples and Comparative Examples.

FIG. 9 shows the relationship between the modulation factor and the track pitch TP of BCA in relation to optical information-recording media manufactured in Examples and Comparative Examples.

FIG. 10 shows the relationship between the track pitch of BCA and ΔIg/ΔIl1 or ΔIl1/ΔIg in relation to optical information-recording media manufactured in Examples and Comparative Examples.

FIG. 11 shows another example of emboss pit array pattern of BCA.

### DESCRIPTION OF THE PREFERRED EMBODIMENTS

Embodiments of the optical information-recording medium of the present invention will be explained below with reference to the drawings. However, the present invention is not limited thereto.

Format Structure of Optical Information-Recording Medium

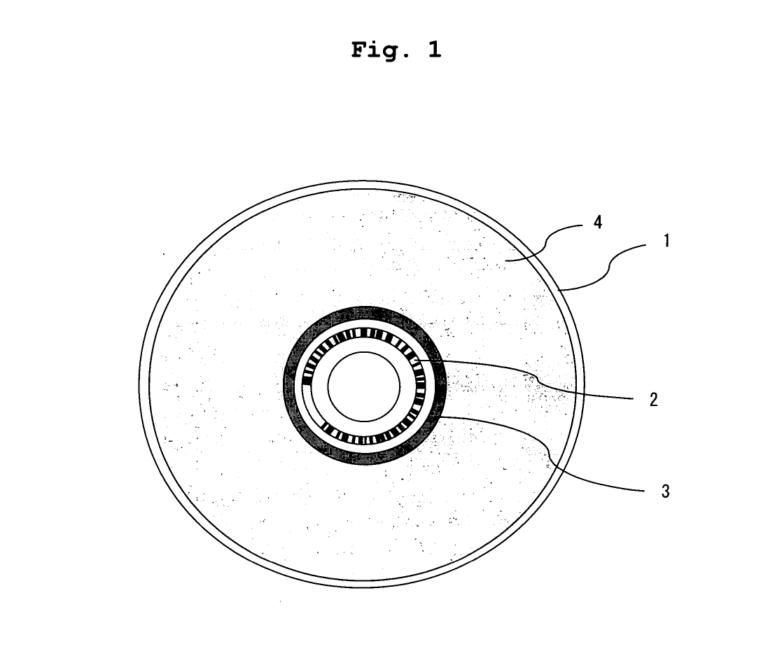

The optical information-recording medium of the present invention is a medium including a substrate and a recording layer (light-absorbing layer) formed of a dye material on the substrate. An embodiment of the optical information-recording medium of the present invention is shown in FIG. 1. FIG. 1 shows a schematic plan view illustrating the optical information-recording medium of this embodiment. As shown in FIG. 1, those formed on the optical information-recording medium 1 include BCA 2 for recording management information with the bar code, a management information area 3 for recording management information in relation to the recording of user information, and a user information area 4 for recording user information. BCA 2, the management information area 3, and the user information area 4 are formed in this order from the inner circumferential side.

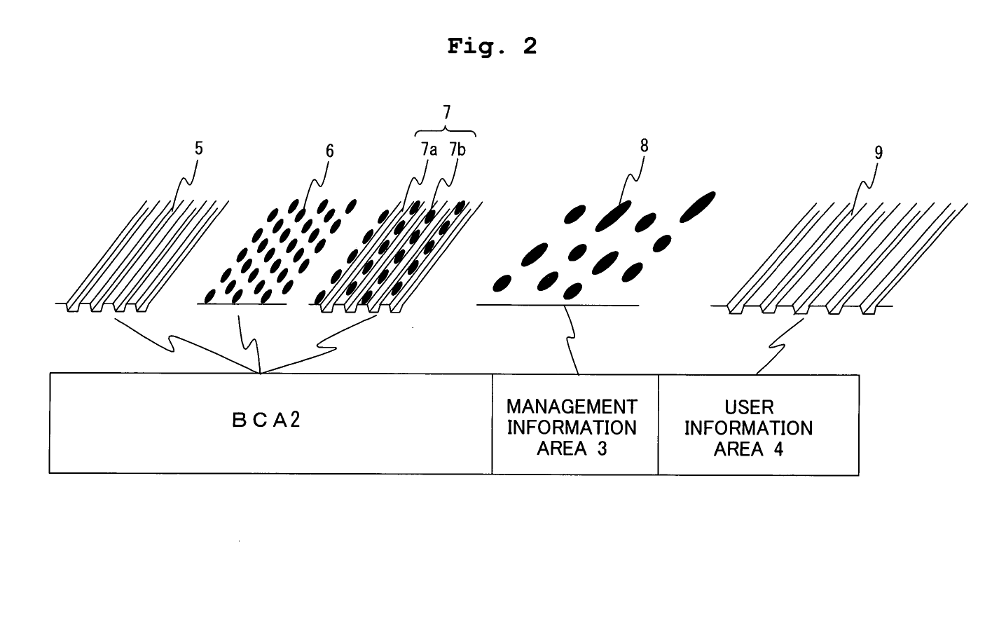

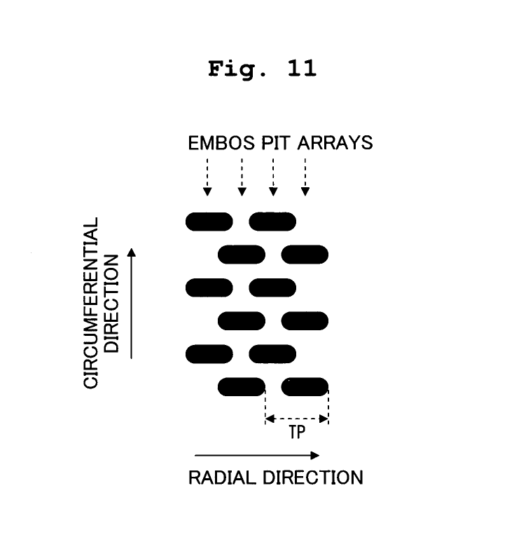

FIG. 2 schematically shows the substrate shape of BCA 2, the management information area 3, and the user information area 4 of the optical information-recording medium of the present invention. In this embodiment, as shown in FIG. 2, BCA 2 is constructed by any one of grooves 5, emboss pit arrays 6, and a concave/convex pattern 7 formed of grooves 7a and emboss pit arrays 7b formed between the grooves. FIG. 2 shows an example of the concave/convex pattern formed in BCA 2 of the optical information-recording medium of the present invention. However, there is no limitation thereto. For example, the concave/convex patterns 5, 6, 7 of BCA 2 may wobble at a specified frequency. FIG. 2 is illustrative of a case of the pattern in which emboss pits having an identical shape are arranged at equal intervals in the track direction. However, any emboss pit array pattern may be used provided that the shape satisfies the expression (2) or (3) described above. For example, as shown in FIG. 11, it is also allowable to use an emboss pit array pattern in which parts of emboss pits of a track adjacent to a predetermined track are formed in an area between emboss pits adjoining in the circumferential direction of the emboss pit array formed on the predetermined track, i.e., an emboss pit array pattern in which emboss pit arrays are overlapped with each other in the circumferential direction between the adjoining tracks.

As shown in FIG. 2, emboss pits 8, which indicate the management information, are formed in the management information area 3. Grooves 9, in which pits are formed when the information is recorded, are formed in the user information area 4. As for the grooves 9 of the user information area 4, the grooves 9 may wobble at a specified frequency, or the grooves 9 may include pits in order to add the address information. The pits or the grooves in the respective areas are formed in a spiral form or in a concentric form.

Structure of BCA

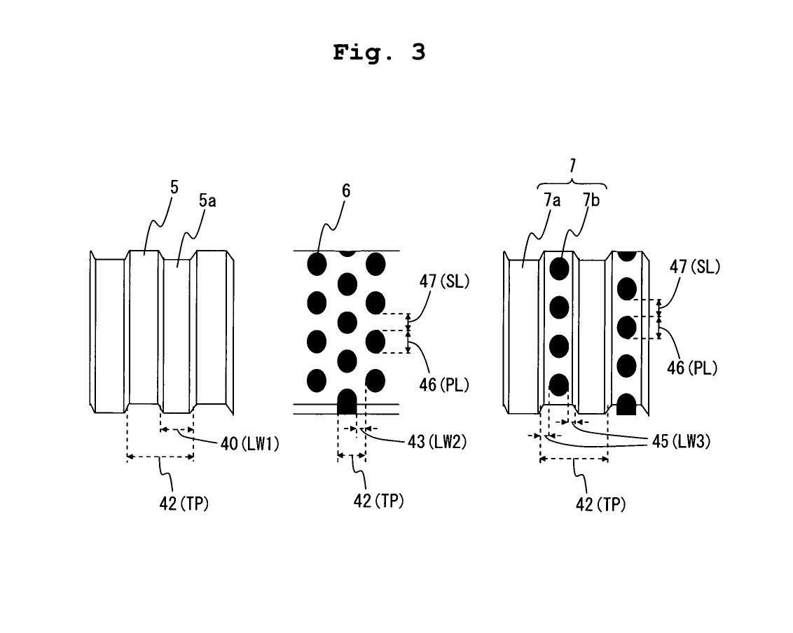

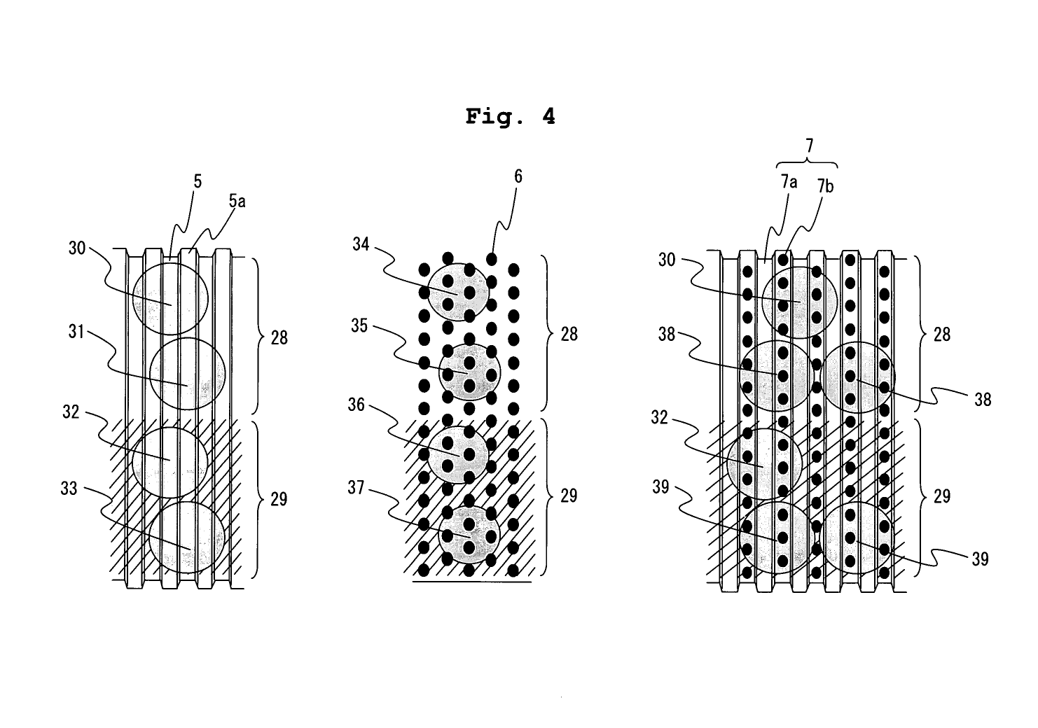

The structure of BCA 2 of the optical information-recording medium of this embodiment will now be explained in further detail with reference to FIGS. 3 and 4.

The depth of the groove and/or the emboss pit formed in BCA 2 can be arbitrarily set depending on, for example, the specification and the film structure. However, usually, the depth is preferably 30 to 120 nm. More desirably, the depth is appropriately 50 to 100 nm, for the following reason. That is, the depth as described above is preferred to secure the satisfactory groove signal characteristic and/or the recording characteristic for the user information area. However, even when the depth range is applied to BCA 2, the same or equivalent effect is obtained. That is, the range of the depth as described above is also an optimum depth range in order that the film thickness of the dye material on BCA 2 is the film thickness necessary to obtain the satisfactory signal characteristic.

When the concave/convex pattern of BCA 2 is formed with only the grooves (left part of FIG. 3), the following relational expression holds provided that LW1 represents the width 40 between the grooves (land portion) 5a:
(i LW1×NA)/λ≦0.3 (2)
In the expression, λ represents the wavelength of the recording and reproducing laser of the driving unit for the optical disk, and NA represents the numerical aperture of the objective lens of the recording and reproducing pickup. As shown in the left part of FIG. 3, LW1 represents the half value width between the grooves (land portion) 5a.

When the concave/convex pattern of BCA 2 is formed with only the emboss pit arrays (middle part of FIG. 3), the following relational expression holds provided that LW2 represents the width 43 between the emboss pit arrays 6:
(LW2×NA)/λ<0.3 (3)
As shown in the middle part of FIG. 3, the width LW2 between the emboss pit arrays 6 is the distance between the endmost portions of the mutually opposing pits in the radial direction of the track (horizontal direction in the drawing) between the mutually adjoining emboss pit arrays 6 as shown in the middle part of FIG. 3.

When the concave/convex pattern of BCA 2 is formed with the grooves and the emboss pit arrays provided between the grooves (right part of FIG. 3), the following relational expression holds provided that LW3 represents the wider width of the widths 45 between the emboss pit array 7b and the grooves 7a positioned on the both sides thereof:
(LW3×NA)/λ≦0.3 (4)
As shown in the right part of FIG. 3, LW3 is the distance from the endmost portion in the radial direction of the emboss pit array 7b to the position of the side wall of the groove 7a opposed to the endmost portion at which the depth is ½ of the groove depth.

As described above, the concave/convex pattern is formed in BCA 2 in the optical information-recording medium of the present invention. Therefore, even when the recording layer is formed by coating the dye material by means of the spin coat method to provide such a film thickness that the recording characteristic of the user information area is optimized, the dye material remains at the emboss pit portion and the groove portion of BCA 2. Thus, the film thickness of the recording layer on BCA 2 is sufficiently thick. On the other hand, any sufficient BCA signal characteristic is not obtained from the land portion, because the dye film thickness is thin at the land portion other than the emboss pit portion and the groove portion of BCA 2. However, in the case of the optical information-recording medium of this embodiment, the concave/convex pattern of BCA 2 is formed to satisfy any one of the expressions (2) to (4). Therefore, the area of the land portion is smaller than the optical resolution λ/(2·NA) of the optical disk drive to be used for the recording and reproduction, which has a completely indistinguishable size. In this arrangement, when the reproducing laser is radiated onto BCA 2 without performing any tracking, the reproducing laser is radiated to traverse the land portion and the track portion of BCA 2 due to the eccentricity of the medium. However, the area of the land portion is smaller than the optical resolution. Therefore, it is possible to obtain, from BCA, the reproduced signal formed by averaging the reproduced signal of the land portion at which the signal amplitude is scarcely obtained and the reproduced signal of the groove portion and/or the emboss pit portion at which the sufficient signal amplitude is obtained. Therefore, when the concave/convex pattern of BCA 2 is formed to satisfy any one of the expressions (2) to (4) as in the optical information-recording medium of this embodiment, then it is possible to suppress the amplitude fluctuation of the BCA reproduced signal, and it is possible to obtain the modulation factor of the BCA reproduced signal amplitude with which no problem arises in the reproduction, i.e., the satisfactory BCA reproduction characteristic. In this case, the BCA reproduced signal is averaged depending on the ratio between the area (land portion) in which the BCA reproduced signal is scarcely obtained and the area (groove portion and/or emboss pit array portion) in which the BCA reproduced signal is obtained at the sufficient intensity. Therefore, it is desirable that the ratio of the groove portion and/or the emboss pit portion is preferably increased with respect to the width of the land portion.

In the optical information-recording medium of this embodiment, it is preferable that the track pitch 42 (TP) of BCA 2 is smaller than the track pitch (TPy) of the user information area (the expression (1) is satisfied) in any one of the concave/convex patterns of BCA 2 shown in FIG. 3.

In the optical information-recording medium of this embodiment, it is preferable that the track pitch 42 (TP) of BCA 2 is set so that the following relationship holds among the track pitch 42 (TP) of BCA 2, the recording and reproducing laser wavelength λ of the optical disk driving unit, and the numerical aperture NA of the objective lens of the recording and reproducing pickup:
(TP×NA)/λ≦0.6 (5)
More desirably, it is preferable that the track pitch 42 (TP) of BCA 2 is set so that the following relationship holds:
0.45≦(TP×NA)/λ≦0.6 (6)
That is, it is preferable that the track pitch TP of BCA 2 is decreased to be as small as possible in order so that the track pitch would be close to the optical resolution λ/(2·NA) of the optical disk drive to be used for the recording and reproduction, or the track pitch TP of BCA 2 is not more than the optical resolution. When (TP×NA)/λ is not more than 0.5, the track of BCA 2 has a size which is completely not more than the optical resolution.

When the track pitch TP of BCA 2 is set to satisfy the relationship of the expression (5) or (6), it is possible to decrease the influence which would be otherwise caused such that the amplitude of the reproduced signal is fluctuated due to the cross-track signal, even when the BCA information is reproduced without performing any tracking. That is, when the track pitch TP of BCA 2 is made to be close to the optical resolution, or the track pitch TP of BCA 2 is made to be not more than the optical resolution, then the concave/convex pattern of BCA 2 is viewed in the same manner as the mirror section is viewed, when the pattern is viewed from the side of the optical disk drive (reproducing light beam). Therefore, only the contrast of the recorded BCA information is reproduced as the signal.

Further, when (TP×NA)/λ is not less than 0.45 as indicated by the expression (6), the groove and the emboss pits can be manufactured in BCA 2 by using the same exposure apparatus (i.e., the same laser) as the exposure apparatus used to form the grooves and the emboss pits in the management information area and the user information area, upon the process of producing a master disk as one of the steps of manufacturing the optical information-recording medium 1. Accordingly, the productivity is remarkably improved.

The range of the track pitch TP of BCA 2 to satisfy the expression (5) or (6) will be explained more specifically. For example, when the laser having a wavelength of 405 nm and the objective lens having NA of 0.65 are used upon the recording and reproduction of the information, it is possible to obtain the modulation factor of the reproduced signal amplitude which causes no problem to reproduce the information of BCA 2, when all of LW1, LW2, and LW3 of the concave/convex pattern of BCA 2 shown in FIG. 3 are not more than about 187 nm. Further, when the track pitch TP of BCA 2 is not more than about 374 nm, the amplitude fluctuation, which is caused by the cross-track signal, can be reduced to such an extent that any influence is not substantially exerted. When the track pitch TP of BCA 2 is not less than 280 nm, all of BCA, the management information area, and the user data area can be manufactured by the same exposure apparatus. Therefore, the productivity is remarkably improved.

In view of the reduction of the amplitude fluctuation of the BCA reproduced signal affected by the eccentricity of the optical information-recording medium (affected by the cross-track signal), it is desirable that the width LW1 between the grooves of BCA 2, the width LW2 between the emboss pit arrays, the width LW3 between the emboss pit array and the groove, and the track pitch TP ((TP×NA)/λ), which are shown in the expressions (2) to (5) respectively, are decreased to be as small as possible. However, the lower limits of the widths and the track pitch are limited in view of the production. In the case of the current technique, the track pitch TP is limited to about 200 nm. The limit of the width between the grooves or between the emboss pit arrays slightly differs depending on the depth of the groove or the emboss pit. However, the limit of the width is about 100 nm in average.

As for the concave/convex patterns having the emboss pits (concave/convex patterns in the middle and right parts of FIG. 3), it is preferable that the following relationships hold among the pit length 46 (PL) of the emboss pit, the spacing length 47 (SL) between the pits, the recording and reproducing laser wavelength λ of the optical disk driving unit, and the numerical aperture NA of the objective lens of the recording and reproducing pickup:
(PL×NA)/λ≦0.6
(SL×NA)/λ≦0.6
More desirably, it is preferable that the following relationships hold:
(PL×NA)/λ≦0.5
(SL×NA)/λ≦0.5
When the concave/convex pattern having the emboss pits is formed so that the relationships as described above hold, then the pit length 46 (PL) of the emboss pit and the spacing length 47 (SL) between the pits are made close to the optical resolution λ/(2·NA) of the optical disk drive to be used for the recording and reproduction, or they are made to be not more than λ/(2·NA). Therefore, even when the recording and reproducing laser is radiated to such a concave/convex pattern, the emboss pits and the spacing between the emboss pits are not recognized, which are viewed in the same manner as the mirror surface is viewed from the optical disk drive. Therefore, any harmful influence such as the amplitude fluctuation is hardly exerted on the reproduced signal of BCA.

As described above, it has been revealed that the following reproduced signal characteristics of BCA are obtained by forming the concave/convex pattern of BCA to satisfy the relational expressions (1) to (6) (see FIG. 4 as well). Details of the following reproduced signal characteristics of BCA will be explained in Examples described later on.

(1) The minimum amplitude Imin of the reproduced signal of BCA can be made larger than the amplitude CT of the cross-track signal. It is possible to reproduce the BCA information more correctly.

(2) The modulation factor (RH−RL)/RH at the minimum amplitude of the BCA reproduced signal is not less than 0.2. It is possible to obtain the BCA reproduced signal having the good signal quality.

(3) The reproduced signal can be obtained so that the following relationships hold between the level difference ΔIg (amplitude of the BCA reproduced signal) between the reproduced signal levels obtained from the non-recorded portion 28 and the recorded portion 29 of BCA respectively when the spot center of the reproducing beam is positioned at the center of the groove 5 (states of circles 30, 32 in the left part of FIG. 4) and the level difference ΔIl1 (amplitude of the BCA reproduced signal) between the reproduced signal levels obtained from the non-recorded portion 28 and the recorded portion 29 of BCA respectively when the spot center of the reproducing beam is positioned at the center between the grooves (states of circles 31, 33 in the left part of FIG. 4), when the BCA information is reproduced by radiating the reproducing beam onto BCA without performing any tracking when the concave/convex pattern of BCA is formed with only the

grooves:
ΔIg/ΔIl1≦1.4 in the case of ΔIg≧ΔIl1,
ΔIl1/ΔIg≦1.4 in the case of ΔIl1≧ΔIg.
That is, when the grooves are formed in BCA so that the expression (2) is satisfied, it is possible to obtain, from BCA, the reproduced signal which undergoes the extremely small amplitude fluctuation. In the relational expressions described above, the relationship of relative magnitude between the level differences ΔIg and ΔIl1 is classified into the cases, for the following reason. That is, the relationship of relative magnitude between the reflectance of the non-recorded portion and the reflectance of the recorded portion is changed depending on the dye material for forming the recording layer, and the relationship of relative magnitude between the level differences ΔIg and ΔIl1 is changed as well.

(4) The reproduced signal can be obtained so that the following relationships hold between the level difference ΔIp between the reproduced signal levels obtained from the non-recorded portion 28 and the recorded portion 29 of BCA respectively when the spot center of the reproducing beam is positioned at the center of the emboss pit array (states of circles 35, 37 in the middle part of FIG. 4) and the level difference ΔIo between the reproduced signal levels obtained from the non-recorded portion 28 and the recorded portion 29 of BCA respectively when the spot center of the reproducing beam is positioned at the center between the emboss pit arrays (states of circles 34, 36 in the middle part of FIG. 4), when the BCA information is reproduced by radiating the reproducing beam onto BCA without performing any tracking when the concave/convex pattern of BCA is formed with only the emboss pit arrays:
ΔIp/ΔIo≦1.4 in the case of ΔIp≧ΔIo,
ΔIo/ΔIp≦1.4 in the case of ΔIo≧ΔIp.
That is, when the emboss pit arrays are formed in BCA so that the expression (3) is satisfied, it is possible to obtain, from BCA, the reproduced signal which undergoes the extremely small amplitude fluctuation.

(5) The reproduced signal can be obtained so that the following relationships hold between the level difference ΔIg between the reproduced signal levels obtained from the non-recorded portion 28 and the recorded portion 29 of BCA respectively when the spot center of the reproducing beam is positioned at the center of the groove (states of circles 30, 32 in the right part of FIG. 4) and the level difference ΔIl2 between the reproduced signal levels obtained from the non-recorded portion 28 and the recorded portion 29 of BCA respectively when the spot center of the reproducing beam is positioned at the center between the groove and the emboss pit array (states of circles 38, 39 in the right part of FIG. 4), when the BCA information is reproduced by radiating the reproducing beam onto BCA without performing any tracking when the concave/convex pattern of BCA is formed with the grooves and the emboss pit arrays provided between the grooves:
ΔIg/ΔIl2≦1.4 in the case of ΔIg≧ΔIl2,
ΔIl2/ΔIg≦1.4 in the case of ΔIl2≧ΔIg.
That is, when the grooves and the emboss pit arrays are formed in BCA so that the expression (4) is satisfied, it is possible to obtain, from BCA, the reproduced signal which undergoes the extremely small amplitude fluctuation.
Film Structure of Optical Information-Recording Medium

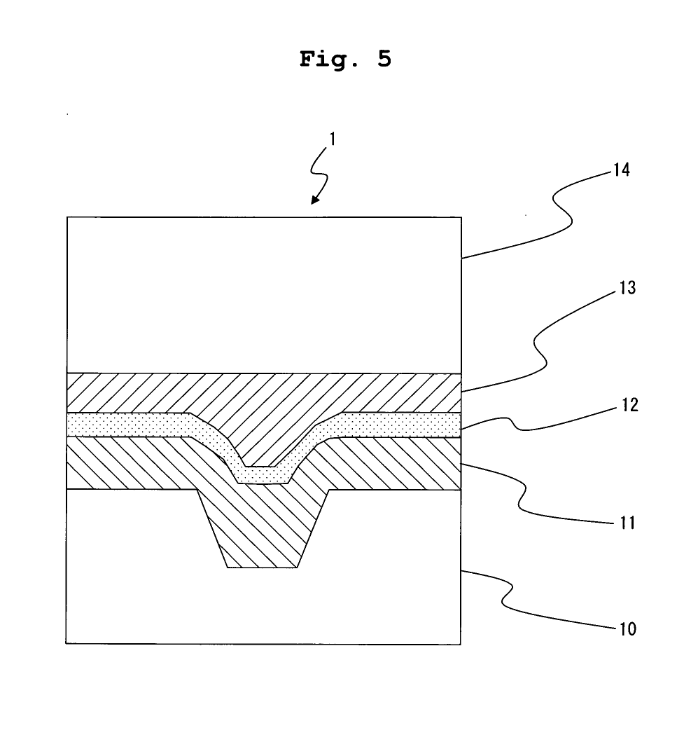

The film structure of the optical information-recording medium of this embodiment will be explained. FIG. 5 shows a schematic sectional view illustrating the optical information-recording medium 1. As shown in FIG. 5, the optical information-recording medium of this embodiment has such a structure that a light-absorbing layer 11 (recording layer), a reflective layer 12, an adhesive layer 13, and a dummy substrate 14 are formed in this order on a light-transmissive substrate 10 having pits and grooves. The recording layer 11 is a layer having such a function that the heat is generated by absorbing the radiated laser beam to cause melting, evaporation, sublimation, deformation, or modification so that pits are formed on the surface of the substrate 10 or the recording layer 11. It is also allowable to provide a solvent-resistant layer and an enhance layer composed of, for example, SiO₂ or ZnS—SiO₂ between the substrate 10 and the recording layer 11.

It is preferable that the substrate 10 is manufactured by means of the injection molding by manufacturing a master disk and a stamper. In this embodiment, the master disk was manufactured as follows. At first, a glass master disk having a diameter of 200 mm and a thickness of 6 mm was prepared. One surface of the glass master disk was uniformly coated with a photoresist by using the spin coat method. The thickness of the photoresist was adjusted depending on the depth of the groove or the pit (emboss pit). Subsequently, the glass master disk, on which the photoresist was formed, was installed to a cutting apparatus.

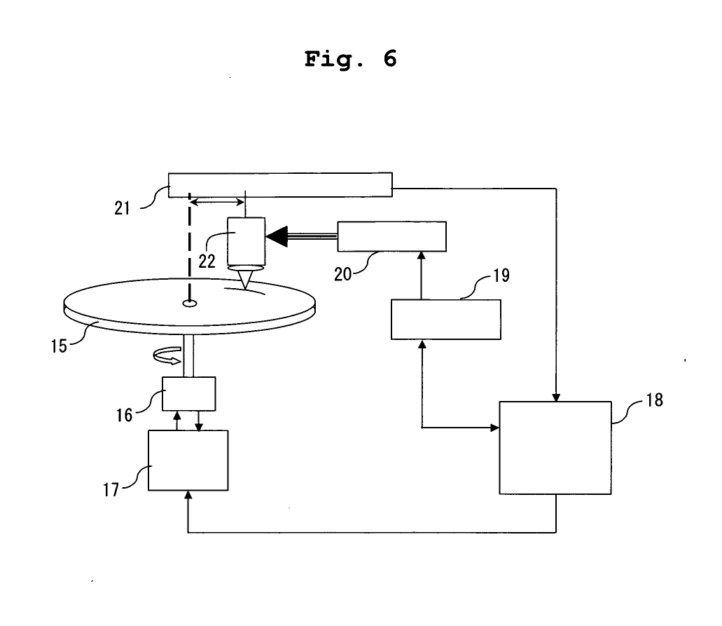

FIG. 6 shows the cutting apparatus for manufacturing the master disk. A recording optical head 22 is driven by a servo system which is movable in the radial direction of the master disk 15 relative to the master disk 15 (not shown). The recording radial position is monitored by a linear scale 21, which is controlled by a closed serve loop. A formatter 19 generates, for example, the information data, the management information, and the groove signal. A recording optical head 22 is driven by the generated signal. The entire system of the cutting apparatus is managed by a controller 18. The track pitch is also serve-controlled by the controller 18. The master disk is driven and rotated by the spindle 16, and a unique servo loop is formed. The spindle 16 is driven by a spindle driver 17.

After the glass master disk was installed to the cutting apparatus, the laser beam from the optical head 22 was radiated onto the photoresist on the glass master disk 15 to perform the exposure in accordance with the information fed from the formatter 19 so that the exposure pattern was formed corresponding to the pit or groove shape. The exposure pattern, which corresponded to the pit size and the groove width, was controlled by regulating the light amount of the laser beam. After the completion of the cutting, the glass master disk was subjected to the known development process to form, on the photoresist, the pit or groove pattern corresponding to the exposure pattern. Subsequently, the electroless plating was applied as the pretreatment for the plating to the pattern formation surface of the glass master disk 15. The plating layer was used as a conductive film to form an Ni layer on the glass master disk 15 by means of the electroforming method. Subsequently, the surface of the Ni layer formed on the glass master disk 15 was polished, and the Ni layer was exfoliated from the glass master disk. Thus, a stamper was obtained. It is also allowable to use the sputtering method and the vapor deposition method as the method for forming the conductive film in the pretreatment for the plating.

In this embodiment, the substrate 10 was manufactured with the injection molding by using the stamper manufactured by the method as described above. A resin, which is excellent in the impact resistance and which is a material having a high transparency with a refractive index in a range of 1.4 to 1.6 with respect to the laser beam, is desirably used as the material for the light-transmissive substrate 10. Specifically, polycarbonate, amorphous polyolefin, and acrylic resin may be exemplified. However, there is no limitation thereto.

It is desirable to use an organic dye having the light-absorbing property as the material for the recording layer 11 (light-absorbing layer). Specifically, those usable include, for example, cyanine dye, polymethine dye, triarylmethane dye, pyrylium dye, phenanthrene dye, azo dye, tetradehydrocholine dye, triarylamine dye, squalirium dye, and chroconicmethine dye. However, the present invention is not limited thereto. The recording layer 11 may also contain, for example, another dye, an additive, a high molecular weight compound (for example, thermoplastic resin such as nitrocellulose and thermoplastic elastomer), and metal fine particles.

The recording layer 11 is formed such that the dye as described above and any arbitrary additive are dissolved or solvated with a known organic solvent (for example, tetrafluoropropanol, ketone alcohol, acetylacetone, methylcellosolve, and toluene), and the light-transmissive substrate 10 is coated therewith. The means, which is used to form the recording layer 11, is the spin coat method. In this method, the film thickness of the recording layer can be controlled by regulating the concentration and viscosity of the dye solution, and the drying speed of the solvent.

The reflective layer 12 is composed of a metal film. The reflective layer 12 is formed, for example, by the means of the sputtering method, for example, with gold, silver, aluminum, or alloy containing any metal as described above. Another layer such as an oxidation resistant layer and an enhance layer composed of, for example, SiO₂, ZnS—SiO₂, or Al₂O₃ may be provided between the recording layer and the reflective layer. It is allowable that any protective layer is formed on the reflective layer 12. It is also allowable that any protective layer is not formed. As for the protective layer, it is possible to use an arbitrary material provided that the layer is capable of protecting the recording layer and the reflective layer. For example, it is possible to use ultraviolet-curable resin and silicone-based resin.

It is desirable that the adhesive layer 13 is formed of a resin which is excellent in the impact resistance. It is preferable to form the adhesive layer 13, for example, such that an ultraviolet-curable resin is coated by means of the spin coat method, followed by being cured by radiating the ultraviolet light. Alternatively, the adhesive layer 13 may be formed of an elastic material such as urethane. In this case, the recording layers may be provided on the both sides of the substrate to be stuck. Alternatively, one substrate may be a dummy substrate provided with no recording layer. If necessary, a printing layer or a printing-receiving layer may be provided on the surface of the substrate on the side of the dummy substrate.

The recording is performed on the optical information-recording medium 1 of this embodiment by radiating the laser beam onto the recording layers or recording layer provided on the both sides or one side of the medium. The thermal change of the substrate, which includes, for example, the decomposition, the heat generation and the carbonization of the dye by the absorption of the laser beam energy, and the melting and the deformation of the substrate, is caused at the portion which is irradiated with the laser beam. The recorded information is reproduced by reading the difference in the refractive index between the portion in which the thermal change is caused and the portion in which the thermal change is not caused by the laser beam.

The embodiment described above is illustrative of the case of the optical information-recording medium in which the laser beam is radiated onto the recording layer through the substrate to perform the recording and reproduction. However, the present invention is not limited thereto. The present invention is also applicable to such an optical information-recording medium that the laser beam is radiated from the side of the film surface onto the recording layer composed of the dye material to perform the recording and reproduction. Further, the present invention is also applicable to such an optical information-recording medium that the light-absorbing layer is formed by means of the spin coat method, wherein the optical information-recording medium has BCA as described above and the user information area.

As for the laser for the driving unit to be used for the recording and reproduction on the optical information-recording medium of the present invention, it is preferable to use a blue laser having a wavelength of 390 nm to 430 nm. It is more preferable to use a blue laser having a wavelength of 400 nm to 420 nm. As for the laser to be used for the BCA writer, it is preferable to use a red laser having a wavelength of 620 nm to 720 nm. It is more preferable to use a red laser having a wavelength of 650 nm to 700 nm. However, the wavelength of the BCA writer is not limited to the range as described above.

The structure of the optical information-recording medium of the embodiment of the present invention, the characteristics of the BCA reproduced signal, and other features will be explained more specifically below as exemplified by Examples.

### EXAMPLE 1

Preparation of Optical Information-Recording Medium

At first, a stamper, which was manufactured by the production method as described above, was installed to a known injection molding machine to manufacture a substrate 10 by injection-molding a polycarbonate resin of the optical information-recording medium grade. The substrate 10 is made of polycarbonate having a diameter of 120 mm and a thickness of 0.6 mm. As shown in FIG. 1, concave/convex patterns of spiral-shaped grooves and/or pits (emboss pits) are transferred onto one surface of the substrate 10 for BCA, the management information area, and the user information area formed on the glass master disk. In Example 1, BCA was formed in an area having radii of 22.20 mm to 23.20 mm. The straight grooves (not wobbled) having a track pitch of 350 nm, a groove width of 240 nm, and a groove depth of 70 nm were formed in BCA. The management information area was formed in an area having radii of 23.40 mm to 23.80 mm. The pits having a track pitch of 680 nm, a pit width of 200 nm, and a pit depth of 70 nm were formed in the management information area. The user information area was formed in an area having radii of 23.80 mm to 58.50 mm. The wobble grooves modulated at a frequency of 700 kHz having a track pitch of 400 nm, a groove width of 210 nm, and a groove depth of 70 nm were formed in the user information area. The pits and the grooves are formed in the spiral form. Therefore, the radii are in the positional relationship at a certain specified angle of the optical information-recording medium.

Subsequently, the surface of the substrate 10, on which the concave/convex patterns were formed, was coated by the spin coat method with a tetrafluoropropanol solution having a concentration of 0.7% by weight of an azo-based dye represented by the following chemical formula (1). When the dye solution was subjected to the coating, the dye solution was filtrated through a filter to remove impurities. The spin coat was performed as follows. That is, 0.5 g of the dye solution was supplied by a dispenser onto the substrate 10 rotated at a number of revolutions of 100 rpm. After that, the substrate was rotated from 1,000 rpm to 3,000 rpm, and the substrate was finally rotated at 5,000 rpm for 2 seconds. In this procedure, the solution was applied so that the thickness was 60 nm at the groove portion. Subsequently, the substrate 10, which had been coated with the dye material, was dried at 80° C. for 1 hour, followed by being cooled at room temperature for 1 hour. Thus, a recording layer 11 (light-absorbing layer) was formed on the substrate 10.

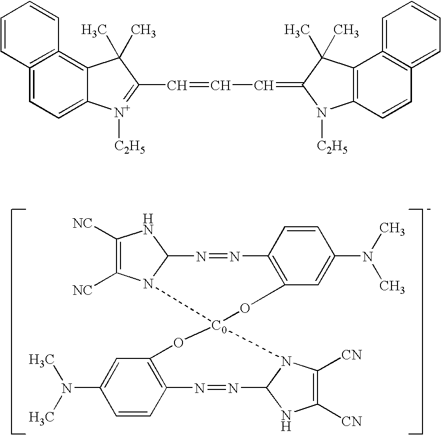

Subsequently, an Ag alloy film was formed as a reflective layer 12 to have a thickness of 130 nm on the recording layer 11 by using the sputtering method. Subsequently, The surface of the reflective layer 12 was coated with a UV resin material as an adhesive layer 13 by means of the spin coat method. Further, a substrate made of polycarbonate having a thickness of 0.6 mm was placed as a dummy substrate 14 thereon. The UV irradiation was performed from the side of the dummy substrate 14 in this state to cure the adhesive layer 13. Accordingly, the substrate 10 formed with the respective layers and the dummy substrate 14 were stuck to one another to obtain an optical information-recording medium of Example 1 (optical information-recording medium A).

The recording film was constructed for the optical information-recording medium A manufactured in Example 1 so that the reflection level (reflectance) after the recording was higher than the reflection level before the recording. However, the present invention is not limited thereto. The recording film may be constructed so that the reflection level after the recording is lower than the reflection level before the recording. In this case, the same or equivalent effect is also obtained.

In Example 1, the concave/convex pattern composed of the straight grooves was formed in BCA. However, the concave/convex pattern of BCA may be formed by using wobbled grooves. In this case, the same or equivalent effect is also obtained.

### COMPARATIVE EXAMPLE 1

In Comparative Example 1, the concave/convex pattern of BCA was formed with grooves. The track pitch was 400 nm, the groove width was 210 nm, and the groove depth was 70 nm. That is, the grooves having the same size as that of the user information area were formed. An optical information-recording medium B was manufactured in the same manner as in Example 1 except that the groove dimension of BCA was changed.

Recording and Reproduction Characteristics of BCA Information

BCA information was recorded as follows on the optical information-recording media A and B manufactured in Example 1 and Comparative Example 1 respectively. In order to record the BCA signal at positions of radii of 22.20 mm to 23.20 mm of the optical information-recording medium, a BCA writer, which had a laser wavelength of 668 nm and a beam diameter of about 1 μm×about 48 μm, was used to record the BCA signal. The BCA code was recorded while setting the condition of a laser power of 900 mW, a linear velocity of 5 m/s, a beam feed amount in the radial direction of 8 μm, a recording start position of 22.1 mm, and a recording end position of 23.3 mm.

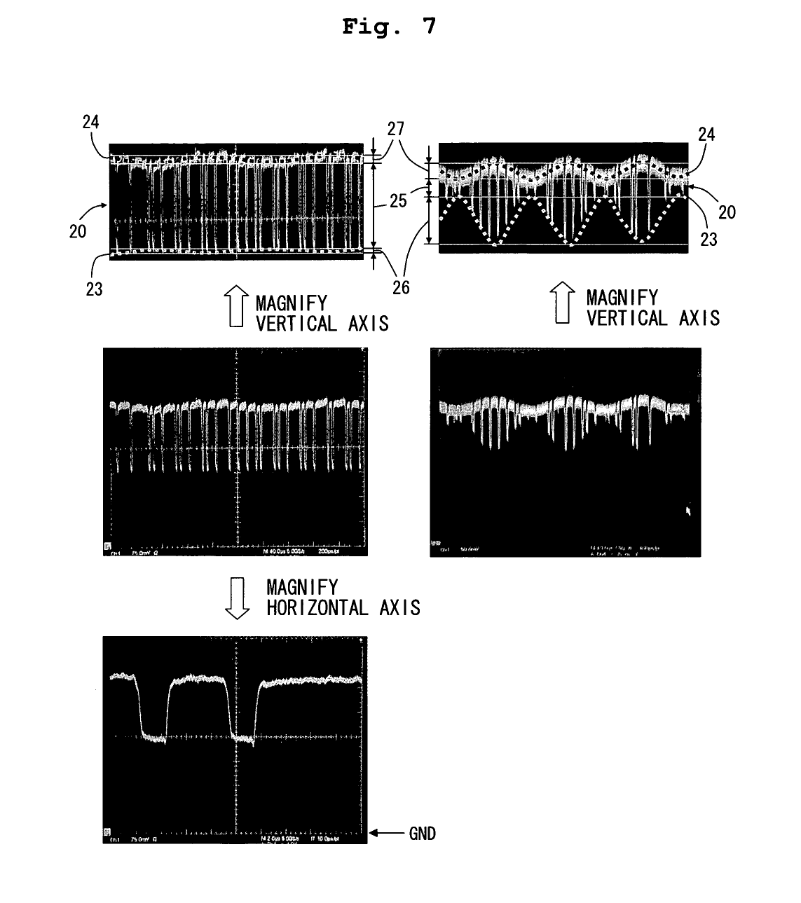

Subsequently, the BCA information was reproduced on each of the optical information-recording media of Example 1 and Comparative Example 1 recorded with the BCA code, in a state in which the focus was effected and the tracking was not effected by using a tester provided with an optical pickup including a laser beam having a wavelength of 405 nm and an objective lens having a numerical aperture of 0.65. FIG. 7 shows photographs of obtained reproduced signal waveforms.

The photographs shown on the left side in FIG. 7 illustrate the BCA reproduced signal waveform of the optical information-recording medium A of Example 1. The waveform photograph shown at the lower part on the left side is a waveform photograph obtained by magnifying the horizontal axis (time axis) of the waveform photograph shown at the middle part on the left side. The waveform photograph shown at the upper part on the left side is a waveform photograph obtained by magnifying the vertical axis (voltage axis) of the waveform photograph shown at the middle part on the left side, which depicts the relationship between the BCA reproduced signal and the cross-track signal. On the other hand, the waveform photographs shown on the right side in FIG. 7 illustrate the BCA reproduced signal waveform of the optical information-recording medium B of Comparative Example 1. The waveform photograph shown at the upper part on the right side is a waveform photograph obtained by magnifying the vertical axis of the waveform photograph shown at the middle part on the right side, which depicts the relationship between the BCA reproduced signal and the cross-track signal.

The waveforms 20, which are shown in the photographs at the upper parts on the left side and the right side in FIG. 7, illustrate the BCA reproduced signal waveforms. The lower peak level of the waveform 20 is the signal level (hereinafter referred to as “Low level” as well) at the non-recorded portion of BCA. The upper peak level of the waveform 20 is the signal level (hereinafter referred to as “High level” as well) at the recorded portion of BCA. The waveforms 23, 24 in the photographs at the upper parts on the left side and the right side in FIG. 7 (waveforms depicted by thick broken lines in the photographs at the upper parts on the left side and the right side in FIG. 7) illustrate the fluctuations of the Low and High levels of the waveforms 20 respectively, which depict the influence of the cross-track signal. That is, the waveform 23 indicates the fluctuation of the reproduced signal level affected by the cross-track signal at the non-recorded portion of BCA. The waveform 24 indicates the fluctuation of the BCA reproduced signal level affected by the cross-track signal at the recorded portion of BCA.

As clarified from the waveform photographs of the BCA reproduced signals shown in FIG. 7, it has been revealed for Comparative Example 1 that the amplitude fluctuation of the BCA reproduced signal waveform 20 is increased by the influence of the cross-track signal, and the amplitude 26 of the cross-track signal at the non-recorded portion of BCA (fluctuation amount of the non-recorded level of the BCA reproduced signal) is larger than the minimum amplitude 25 of the BCA reproduced signal waveform 20. It is difficult to correctly reproduce the BCA information from the BCA reproduced signal waveform 20 having the large amplitude fluctuation as described above. On the other hand, it has been revealed for the optical information-recording medium of Example 1 that both of the amplitudes 26, 27 of the cross-track signal are extremely smaller than the minimum amplitude 25 of the BCA reproduced signal waveform 20.

The modulation factors were measured for the minimum amplitude 25 of the BCA reproduced signal, the amplitude 26 of the cross-track signal at the non-recorded portion of BCA, the amplitude 27 of the cross-track signal at the recorded portion of BCA, and the minimum amplitude of the BCA reproduced signal for each of the optical information-recording media of Example 1 and Comparative Example 1 from the photographs of the BCA reproduced signal waveforms shown in FIG. 7. Obtained results are summarized in Table 1. Usually, the modulation factor of the BCA reproduced signal is represented by (RH−RL)/RH provided that RH represents the higher reflectance and RL represents the lower reflectance of the reflectance of the recorded portion and the reflectance of the non-recorded portion of BCA. However, in this procedure, as for the modulation factor of the BCA reproduced signal, the modulation factor was determined from the level difference at the minimum amplitude of the BCA reproduced signal in place of the reflectance. Specifically, the High level and the Low level at the minimum amplitude of the BCA reproduced signal were designated as RH and RL respectively to calculate (RH−RL)/RH. The obtained value was regarded as the modulation factor at the minimum amplitude of the BCA reproduced signal. The modulation factor determined as described above substantially has the value equivalent to that of the modulation factor determined from the difference of the reflectance. In Table 1, the respective parameters correspond to the-measurement items as follows:

TP: track pitch;

RH: High level at the minimum amplitude of the BCA reproduced signal;

RL: Low level at the minimum amplitude of the BCA reproduced signal;

RH−RL: minimum amplitude of the BCA reproduced signal (amplitude amount 25 in FIG. 7);

Ictu: amplitude of the cross-track signal at the non-recorded portion of BCA (fluctuation amount 26 of Low level shown in FIG. 7);

Ictw: amplitude of the cross-track signal at the recorded portion of BCA (fluctuation amount 27 of High level shown in FIG. 7);

(RH−RL)/RH: modulation factor at the minimum amplitude of the BCA reproduced signal.

TABLE 1

| | Example 1 | Comparative Example 1 |
|---|---|---|
| TP [nm] | 350 | 400 |
| RH − RL [mV] | 177 | 12 |
| Ictu [mV] | 24 | 25 |
| Ictw [mV] | 11 | 63 |
| (RH − RL)/RH | 0.42 | 0.05 |

As clarified from Table 1, in the case of the optical information-recording medium A of Example 1, the minimum amplitude of the BCA reproduced signal (RH−RL in Table 1) was larger than the amplitude of the cross-track signal (Ictw and Ictu in Table 1). The modulation factor ((RH−RL)/Rh in Table 1) greatly exceeded 20%. Further, it has been revealed for the optical information-recording medium A of Example 1 that the amplitude fluctuation of the BCA reproduced signal is also small, and the BCA reproduced signal having the satisfactory signal quality is obtained as compared with Comparative Example 1. On the other hand, in case of the optical information-recording medium B of Comparative Example 1 having the same track pitch of BCA as the track pitch of the user information area, the minimum amplitude of the BCA reproduced signal was smaller than the amplitude of the cross-track signal, and the modulation factor was smaller than 20% as well. Further, in the case of the optical information-recording medium of Comparative Example 1, the amplitude fluctuation of the BCA reproduced signal was large, and the signal quality was also deteriorated. That is, it has been reveled that the BCA reproduced signal, in which the amplitude fluctuation is small and the modulation factor is high, is obtained by narrowing the track pitch TP of the concave/convex pattern of BCA as compared with the track pitch TPy of the user information area as in Example 1.

### EXAMPLE 2

In Example 2, the concave/convex pattern of BCA was formed with grooves, the track pitch was 370 nm, the groove width was 250 nm, the width between the grooves was 120 nm, and the groove depth was 70 nm. An optical information-recording medium C was manufactured in the same manner as in Example 1 except that the groove dimension of BCA was changed.

### EXAMPLE 3

In Example 3, the concave/convex pattern of BCA was formed with grooves, the track pitch was 370 nm, the groove width was 220 nm, the width between the grooves was 150 nm, and the groove depth was 70 nm. An optical information-recording medium D was manufactured in the same manner as in Example 1 except that the groove dimension of BCA was changed.

### EXAMPLE 4

In Example 4, the concave/convex pattern of BCA was formed with grooves, the track pitch was 370 nm, the groove width was 190 nm, the width between the grooves was 180 nm, and the groove depth was 70 nm. An optical information-recording medium E was manufactured in the same manner as in Example 1 except that the groove dimension of BCA was changed.

### EXAMPLE 5

In Example 5, the concave/convex pattern of BCA was formed with emboss pit arrays, the track pitch was 370 nm, the pit width of the emboss pit array was 190 nm, the width between the pit arrays was 180 nm, the pit length was 250 nm, the pit spacing was 150 nm, and the pit depth was 70 nm. An optical information-recording medium F was manufactured in the same manner as in Example 1 except that the concave/convex pattern of BCA was changed.

### EXAMPLE 6

In Example 6, the concave/convex pattern of BCA was formed with grooves and emboss pit arrays provided between the grooves, and the track pitch was 370 nm. The groove width was 100 nm, and the groove depth was 70 nm. The pit width of the emboss pit array was 60 nm, the pit length was 300 nm, the pit spacing was 100 nm, and the pit depth was 70 nm. The widths between the emboss pit array and the grooves positioned on the both sides thereof were 180 nm and 30 nm respectively. An optical information-recording medium G was manufactured in the same manner as in Example 1 except that the concave/convex pattern of BCA was changed.

### COMPARATIVE EXAMPLE 2

In Comparative Example 2, the concave/convex pattern of BCA was formed with grooves, the track pitch was 370 nm, the groove width was 180 nm, the width between the grooves was 190 nm, and the groove depth was 70 nm. An optical information-recording medium H was manufactured in the same manner as in Example 1 except that the concave/convex pattern of BCA was changed.

### COMPARATIVE EXAMPLE 3

In Comparative Example 3, the concave/convex pattern of BCA was formed with grooves, the track pitch was 370 nm, the groove width was 150 nm, the width between the grooves was 220 nm, and the groove depth was 70 nm. An optical information-recording medium I was manufactured in the same manner as in Example 1 except that the concave/convex pattern of BCA was changed.

### COMPARATIVE EXAMPLE 4

In Comparative Example 4, the concave/convex pattern of BCA was formed with emboss pit arrays, the track pitch was 370 nm, the pit width of the emboss pit array was 180 nm, the width between the pit arrays was 190 nm, the pit length was 300 nm, the pit spacing was 100 nm, and the pit depth was 70 nm. An optical information-recording medium J was manufactured in the same manner as in Example 1 except that the concave/convex pattern of BCA was changed.

### COMPARATIVE EXAMPLE 5

In Comparative Example 5, the concave/convex pattern of BCA was formed with grooves and emboss pit arrays provided between the grooves, and the track pitch was 370 nm. The groove width was 100 nm, and the groove depth was 70 nm. The pit width of the emboss pit array was 60 nm, the pit length was 250 nm, the pit spacing was 150 nm, and the pit depth was 70 nm. The widths between the emboss pit array and the grooves positioned on the both sides thereof were 190 nm and 20 nm respectively. An optical information-recording medium K was manufactured in the same manner as in Example 1 except that the concave/convex pattern of BCA was changed.

Recording and Reproduction Characteristics of BCA Information

The BCA code was also recorded in BCA in the same manner as in Example 1 on the optical information-recording media manufactured in Examples 2 to 6 and Comparative Examples 2 to 5. The BCA information was reproduced on each of the optical information-recording media in a state in which the focus was effected and the tracking was not effected by using a tester provided with an optical pickup including a laser beam having a wavelength of 405 nm and an objective lens having a numerical aperture of 0.65 in the same manner as in Example 1 to measure the modulation factor at the minimum amplitude of the BCA reproduced signal. Obtained results are shown in Tables 2 and 3. The respective parameters in Tables 2 and 3 have the following meanings:

TP: track pitch of BCA;

LW1: width between the grooves of BCA;

LW2: width between the emboss pit arrays of BCA;

LW3: wider width of the widths between the emboss pit array and the grooves on the both sides thereof of BCA;

NA: lens numerical aperture of the tester;

λ: laser wavelength of the tester;

RH: High level at the minimum amplitude of the BCA reproduced signal;

RL: Low level at the minimum amplitude of the BCA reproduced signal;

(RH−RL)/RH: modulation factor at the minimum amplitude of the BCA reproduced signal.

TABLE 2

| | Exam- | Exam- | Exam- | | |
|---|---|---|---|---|---|
| | ple 2 | ple 3 | ple 4 | Comparative | Comparative |
| | Medi- | Medi- | Medi- | Example 2 | Example 3 |
| | um C | um D | um E | Medium H | Medium I |
| TP [nm] | all 370 | | | | |
| LW1 [nm] | 120 | 150 | 180 | 190 | 220 |
| (LW1 × | 0.193 | 0.241 | 0.289 | 0.305 | 0.353 |
| NA)/λ | | | | | |
| (RH − RL)/RH | 0.28 | 0.24 | 0.21 | 0.19 | 0.16 |

TABLE 3

| | | | | Comparative |
|---|---|---|---|---|
| | | Example 6 | Comparative | Example 5 |
| | Example 5 | Medium G | Example 4 | Medium K |
| | Medium F | groove + | Medium J | groove + |
| | emboss pit | emboss pit | emboss pit | emboss pit |
| Shape of BCA | array | array | array | array |
| TP [nm] | all 370 | | | |
| LW2 [nm] | 180 | — | 190 | — |
| LW3 [nm] | — | 180 | — | 190 |
| (LW2 × NA)/λ | 0.289 | — | 0.305 | — |
| (LW3 × NA)/λ | — | 0.289 | — | 0.305 |
| (RH − RL)/RH | 0.205 | 0.23 | 0.197 | 0.19 |

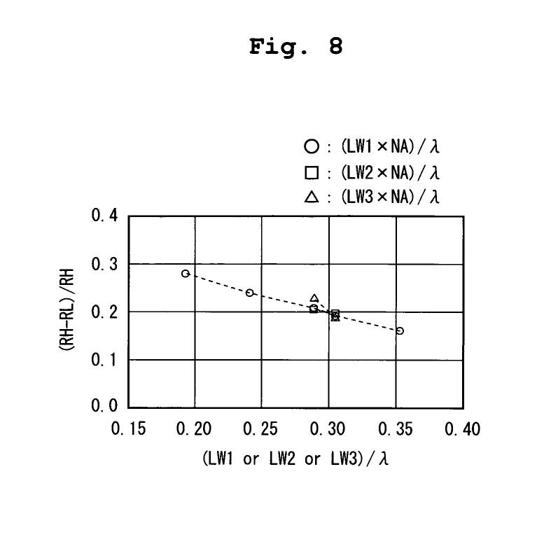

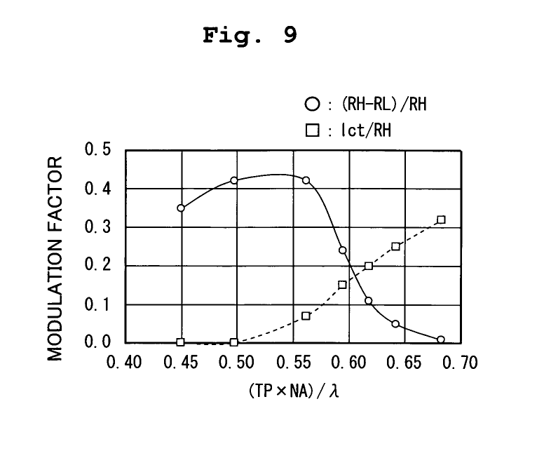

According to the results shown in Tables 2 and 3, the relationships between the modulation factor (RH−RL)/RH and (LW1×NA)/λ, (LW2×NA)/λ, and (LW3×NA)/λ are shown in FIG. 8. In FIG. 8, the horizontal axis represents (LW1×NA)/λ, (LW2×NA)/λ, or (LW3×NA)/λ, and the vertical axis represents the modulation factor (RH−RL)/RH. As clarified from FIG. 8, the following result is obtained when BCA is formed with the concave/convex pattern composed of the grooves. That is, when (LW1×NA)/λ is increased, i.e., when the width LW1 (land portion) between the grooves is increased, the modulation factor (RH−RL)/RH is linearly decreased. Further, it has been revealed that the modulation factor at the minimum amplitude of the BCA reproduced signal exceeds 20%, and the signal quality is satisfactory, when (LW1×NA)/k is not more than 0.3. Further, the following fact has been revealed. That is, when BCA is formed with the concave/convex pattern composed of the emboss pit arrays or of the grooves and the emboss pit arrays, the characteristics equivalent to those obtained for (LW1×NA)/λ are also obtained as shown in FIG. 8. When (LW2×NA)/λ or (LW3×NA)/λ is not more than 0.3, the modulation factor at the minimum amplitude of the BCA reproduced signal exceeds 20%. In the present invention, the reference of 20% is used as the reference for whether the modulation factor is superior or inferior, for the following reason. As described later on, when the concave/convex pattern of BCA is formed so that the modulation factor at the minimum amplitude of the BCA reproduced signal exceeds 20%, then the modulation factor at the minimum amplitude of the BCA reproduced signal is larger than the modulation factor of the cross-track signal (see FIG. 9), and the BCA information can be reliably reproduced. Therefore, the reference of 20% is used herein as the reference for whether the modulation factor is superior or inferior.

### EXAMPLE 7

In Example 7, the concave/convex pattern of BCA was formed with grooves, the track pitch was 310 nm, the groove width was 200 nm, the width between the grooves was 110 nm, and the groove depth was 70 nm. An optical information-recording medium L was manufactured in the same manner as in Example 1 except that the groove dimension of BCA was changed.

### EXAMPLE 8

In Example 8, the concave/convex pattern of BCA was formed with grooves, the track pitch was 280 nm, the groove width was 200 nm, the width between the grooves was 80 nm, and the groove depth was 70 nm. An optical information-recording medium M was manufactured in the same manner as in Example 1 except that the groove dimension of BCA was changed.

### COMPARATIVE EXAMPLE 6

In Comparative Example 6, the concave/convex pattern of BCA was formed with grooves, the track pitch was 385 nm, the groove width was 190 nm, the width between the grooves was 195 nm, and the groove depth was 70 nm. An optical information-recording medium N was manufactured in the same manner as in Example 1 except that the concave/convex pattern of BCA was changed.

### COMPARATIVE EXAMPLE 7

In Comparative Example 7, the concave/convex pattern of BCA was formed with grooves, the track pitch was 425 nm, the groove width was 210 nm, the width between the grooves was 215 nm, and the groove depth was 70 nm. An optical information-recording medium O was manufactured in the same manner as in Example 1 except for the above.

Recording and Reproduction Characteristics of BCA Information

The BCA code was also recorded in BCA in the same manner as in Example 1 on the optical information-recording media manufactured in Examples 7 and 8 and Comparative Examples 6 and 7. The BCA information was reproduced on each of the optical information-recording media in a state in which the focus was effected and the tracking was not effected by using a tester provided with an optical pickup including a laser beam having a wavelength of 405 nm and an objective lens having a numerical aperture of 0.65 in the same manner as in Example 1 to measure the minimum amplitude of the BCA reproduced signal and the modulation factor thereof as well as the maximum amplitude of the cross-track signal (larger amplitude fluctuation amount of those of the amplitude fluctuations at Low level and High level of the BCA reproduced signal waveform) and the modulation factor thereof.

Those also measured were the difference (amplitude of the BCA reproduced signal) between the reproduced signal level obtained when the spot center of the reproducing beam of the tester was radiated onto the center of the groove at the non-recorded portion of BCA (state of the circle 30 in the left part of FIG. 4) and the reproduced signal level obtained when the spot center was radiated onto the center of the groove at the recorded portion of BCA (state of the circle 32 in the left part of FIG. 4), as well as the difference (amplitude of the BCA reproduced signal) between the reproduced signal level obtained when the spot center of the reproducing beam of the tester was radiated onto the center between the grooves at the non-recorded portion of BCA (state of the circle 31 in the left part of FIG. 4) and the reproduced signal level obtained when the spot center was radiated onto the center between the grooves at the recorded portion of BCA (state of the circle 33 in the left part of FIG. 4). Obtained results of the measurement are shown in Table 4. The results of the measurement in Examples 1 and 2 and Comparative Example 1 are also shown in Table 4. The respective parameters in Table 4 have the following meanings:

TP: track pitch of BCA;

NA: lens numerical aperture of the tester;

λ: laser wavelength of the tester;

RH: High level at the minimum amplitude of the BCA reproduced signal;

RL: Low level at the minimum amplitude of the BCA reproduced signal;

(RH−RL)/RH: modulation factor at the minimum amplitude of the BCA reproduced signal;

Ict: maximum amplitude of the cross-track signal;

Ict/RH: modulation factor at the maximum amplitude of the cross-track signal;

ΔIg: amplitude of the BCA reproduced signal obtained when the spot center of the reproducing beam is radiated onto the center of the groove;

ΔIl1: amplitude of the BCA reproduced signal obtained when the spot center of the reproducing beam is radiated onto the center between the grooves.

TABLE 4

| | Ex. 1 | Ex. 2 | Ex. 7 | Ex. 8 | Comp. Ex. 1 | Comp. Ex. 6 | Comp. Ex. 7 |
|---|---|---|---|---|---|---|---|
| | Med. A | Med. C | Med. L | Med. M | Med. B | Med. N | Med. O |
| TP [nm] | 350 | 370 | 310 | 280 | 400 | 385 | 425 |
| (TP × NA)/λ | 0.562 | 0.594 | 0.498 | 0.449 | 0.642 | 0.618 | 0.682 |
| RH − RL [mV] | 177 | 102 | 199 | 158 | 12 | 43 | 2 |
| Ict [mV] | 24 | 64 | 0 | 0 | 63 | 80 | 99 |
| (RH − RL)/RH | 0.42 | 0.24 | 0.42 | 0.35 | 0.05 | 0.11 | 0.01 |
| Ict/RH | 0.07 | 0.15 | 0.00 | 0.00 | 0.25 | 0.20 | 0.32 |
| ΔIg/ΔIl1 | 1.28 | 1.36 | 1.17 | 1.12 | 4.71 | 1.83 | 35.00 |
| upon | | | | | | | |
| ΔIg ≧ ΔIl1 | | | | | | | |
| or ΔIl1/ΔIg | | | | | | | |
| upon | | | | | | | |
| ΔIg < ΔIl1 | | | | | | | |

According to the results shown in Table 4, the relationships between (TP×NA)/λ and the modulation factor (RH−RL)/RH and between (TP×NA)/λ and Ict/RH are shown in FIG. 9 when the concave/convex pattern of BCA is formed with the grooves. In FIG. 9, the horizontal axis represents (TP×NA)/λ, and the vertical axis represents the modulation factor (RH−RL)/RH or Ict/RH. The reflectance differs among the optical information-recording media of Examples and Comparative Examples shown in Table 4 respectively. Therefore, in FIG. 9, the values, which are normalized by the High level (RH) at the minimum amplitude of the BCA reproduced signal, are plotted.

As clarified from Table 4, the following result is obtained when BCA is formed with the concave/convex pattern composed of the grooves. That is, it has been revealed that when (TP×NA)/λ is not more than 0.6, then the modulation factor at the minimum amplitude of the BCA reproduced signal is larger than the modulation factor at the maximum amplitude of the cross-track signal, and the modulation factor at the minimum amplitude of the BCA reproduced signal is not less than 20%. That is, it has been revealed that when (TP×NA)/λ is not more than 0.6, then the minimum amplitude of the BCA reproduced signal is larger than the maximum amplitude of the cross-track signal, and the BCA reproduced signal having the satisfactory signal quality is obtained. According to this fact, it has been revealed that when the concave/convex pattern of BCA is formed so that the modulation factor at the minimum amplitude of the BCA reproduced signal is not less than 20%, then the minimum amplitude of the BCA reproduced signal is larger than the maximum amplitude of the cross-track signal, and the BCA information can be reproduced more reliably.

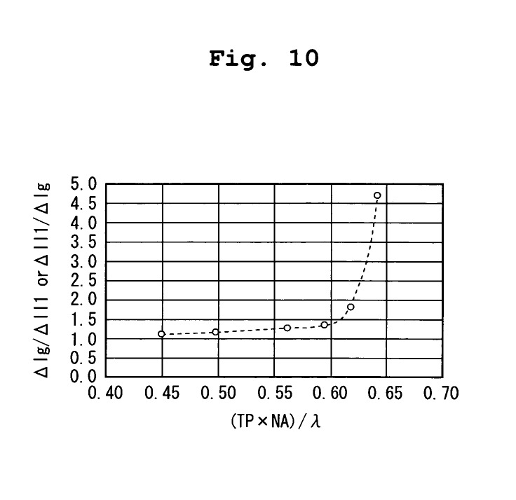

According to the results shown in Table 4, FIG. 10 shows the relationship between (TP×NA)/λ obtained when the concave/convex pattern of BCA is formed with the grooves and the value (ΔIg/ΔIl1 or ΔIl1/ΔIg) obtained by dividing the larger level difference (amplitude) of ΔIg and ΔIl1 by the smaller level difference. In FIG. 10, the horizontal axis represents (TP×NA)/λ, and the vertical axis represents ΔIg/ΔIl1 or ΔIl1/ΔIg. As clarified from FIG. 10, when the concave/convex pattern composed of the grooves is formed in BCA, ΔIg/ΔIl1 or ΔIl1/ΔIg is not more than 1.4 when (TP×NA)/k is not more than 0.6. Thus, it is possible to decrease the amplitude fluctuation. That is, the following fact has been revealed from FIGS. 9 and 10. When the grooves are formed in BCA so that (TP×NA)/λ≦0.6 holds, then the modulation factor at the minimum amplitude of the BCA reproduced signal exceeds 20%, the amplitude fluctuation of the reproduced signal is decreased as well, and the BCA reproduced signal is obtained while providing the satisfactory signal quality. In FIG. 10, the reference for the superiority or inferiority of ΔIg/ΔIl1 or ΔIl1/ΔIg is 1.4. This value is the numerical value obtained just before the sudden increase in ΔIg/ΔIl1 or ΔIl1/ΔIg (fluctuation is increased) when (TP×NA)/λ is increased, as clarified from FIG. 10. Even when ΔIg/ΔIl1 or ΔIl1/ΔIg is somewhat larger than 1.4, it is not approved that the BCA information cannot be reproduced at all. However, it is extremely difficult to practically control the track pitch in the area in which ΔIg/ΔIl1 or ΔIl1/ΔIg is suddenly increased. Therefore, the numerical value of 1.4, which is obtained just before the sudden increase in ΔIg/ΔIl1 or ΔIl1/ΔIg, is herein used as the reference.

### EXAMPLE 9

In Example 9, the concave/convex pattern of BCA was formed with emboss pit arrays, the track pitch was 350 nm, the pit width of the emboss pit array was 190 nm, the width between the pit arrays was 160 nm, the pit length was 200 nm, the pit spacing was 200 nm, and the pit depth was 70 nm. An optical information-recording medium P was manufactured in the same manner as in Example 1 except that the concave/convex pattern of BCA was changed.

### EXAMPLE 10

In Example 10, the concave/convex pattern of BCA was formed with grooves and emboss pit arrays provided between the grooves, and the track pitch was 350 nm. The groove width was 200 nm, and the groove depth was 70 nm. Further, the pit width of the emboss pit array was 100 nm, the pit length was 200 nm, the pit spacing was 200 nm, and the pit depth was 70 nm. The widths between the emboss pit array and the grooves positioned on the both sides thereof were 40 nm and 10 nm respectively. An optical information-recording medium Q was manufactured in the same manner as in Example 1 except that the concave/convex pattern of BCA was changed.

### COMPARATIVE EXAMPLE 8

In Comparative Example 8, the concave/convex pattern of BCA was formed with emboss pit arrays, the track pitch was 400 nm, the pit width of the emboss pit array was 190 nm, the width between the pit arrays was 200 nm, the pit length was 200 nm, the pit spacing was 200 nm, and the pit depth was 70 nm. An optical information-recording medium R was manufactured in the same manner as in Example 1 except that the concave/convex pattern of BCA was changed.

### COMPARATIVE EXAMPLE 9

In Comparative Example 9, the concave/convex pattern of BCA was formed with grooves and emboss pit arrays provided between the grooves, and the track pitch was 400 nm. The groove width was 120 nm, and the groove depth was 70 nm. Further, the pit width of the emboss pit array was 80 nm, the pit length was 200 nm, the pit spacing was 200 nm, and the pit depth was 70 nm. The widths between the emboss pit array and the grooves positioned on the both sides thereof were 190 nm and 10 nm respectively. An optical information-recording medium S was manufactured in the same manner as in Example 1 except that the concave/convex pattern of BCA was changed.

Recording and Reproduction Characteristics of BCA Information

The BCA code was also recorded in BCA in the same manner as in Example 1 on the optical information-recording media manufactured in Examples 9 and 10 and Comparative Examples 8 and 9. The BCA information was reproduced on each of the optical information-recording media in a state in which the focus was effected and the tracking was not effected by using a tester provided with an optical pickup including a laser beam having a wavelength of 405 nm and an objective lens having a numerical aperture of 0.65 in the same manner as in Example 1 to measure the minimum amplitude of the BCA reproduced signal and the modulation factor thereof as well as the maximum amplitude of the cross-track signal (larger amplitude fluctuation amount of those of the amplitude fluctuations at Low level and High level of the BCA reproduced signal waveform).

As for the optical information-recording media (Example 9 and Comparative Example 8) having BCA formed with only the emboss pits, measurements were performed to obtain the difference (amplitude of the BCA reproduced signal) between the reproduced signal level obtained when the spot center of the reproducing beam of the tester was radiated onto the center of the emboss pit array at the non-recorded portion of BCA (state of the circle 35 in the middle part of FIG. 4) and the reproduced signal level obtained when the spot center was radiated onto the center of the emboss pit array at the recorded portion of BCA (state of the circle 37 in the middle part of FIG. 4), as well as the difference (amplitude of the BCA reproduced signal) between the reproduced signal level obtained when the spot center of the reproducing beam of the tester was radiated onto the center between the emboss pit arrays at the non-recorded portion of BCA (state of the circle 34 in the middle part of FIG. 4) and the reproduced signal level obtained when the spot center was radiated onto the center between the emboss pit arrays at the recorded portion of BCA (state of the circle 36 in the left part of FIG. 4).

Further, as for the optical information-recording media (Example 10 and Comparative Example 9) having BCA formed with the grooves and the emboss pits, measurements were performed to obtain the difference (amplitude of the BCA reproduced signal) between the reproduced signal level obtained when the spot center of the reproducing beam of the tester was radiated onto the center of the groove at the non-recorded portion of BCA (state of the circle 30 in the right part of FIG. 4) and the reproduced signal level obtained when the spot center was radiated onto the center of the groove at the recorded portion of BCA (state of the circle 32 in the middle part of FIG. 4), as well as the difference (amplitude of the BCA reproduced signal) between the reproduced signal level obtained when the spot center of the reproducing beam of the tester was radiated onto the center between the groove and the emboss pit array at the non-recorded portion of BCA (state of the circle 38 in the middle part of FIG. 4) and the reproduced signal level obtained when the spot center was radiated onto the center between the groove and the emboss pit array at the recorded portion of BCA (state of the circle 39 in the left part of FIG. 4). Obtained results of the measurement are shown in Table 5. The respective parameters in Table 5 have the following meanings:

TP: track pitch of BCA;

RH: High level at the minimum amplitude of the BCA reproduced signal;

RL: Low level at the minimum amplitude of the BCA reproduced signal;

(RH−RL)/RH: modulation factor at the minimum amplitude of the BCA reproduced signal;

Ict: maximum amplitude of the cross-track signal;

ΔIg: amplitude of the reproduced signal obtained when the spot center of the reproducing beam is radiated onto the center of the groove of BCA;

ΔIl2: amplitude of the reproduced signal obtained when the spot center of the reproducing beam is radiated onto the center between the emboss pit array and the groove of BCA;

ΔIp: amplitude of the reproduced signal obtained when the spot center of the reproducing beam is radiated onto the center of the emboss pit array of BCA;

ΔIo: amplitude of the reproduced signal obtained when the spot center of the reproducing beam is radiated onto the center between the emboss pit arrays of BCA.

TABLE 5

| | | Example 10 | | Comp. Ex. 9 |
|---|---|---|---|---|
| | Example 9 | Medium Q | Comp. Ex. 8 | Medium S |
| | Medium P | groove + | Medium R | groove + |
| | emboss pit | emboss pit | emboss pit | emboss pit |
| Shape of BCA | array | array | array | array |
| TP [nm] | 350 | 350 | 400 | 400 |
| RH − RL [mV] | 180 | 230 | 14 | 29 |
| Ict [mV] | 19 | 28 | 58 | 98 |
| (RH − RL)/RH | 0.36 | 0.49 | 0.04 | 0.07 |
| ΔIg/ΔIl2 | — | 1.20 | — | 3.26 |
| upon | | | | |
| ΔIg ≧ ΔIl2 | | | | |
| or | | | | |
| ΔIl2/ΔIg | | | | |
| upon | | | | |
| ΔIg < ΔIl2 | | | | |
| ΔIP/ΔIo upon | 1.32 | — | 5.62 | — |
| ΔIp ≧ ΔIo | | | | |
| or | | | | |
| ΔIo/ΔIp upon | | | | |
| ΔIp < ΔIo | | | | |

As clarified from Table 5, in the case of the optical information-recording media of Examples 9 and 10, the minimum amplitude (RH−RL) of the reproduced signal was larger than the maximum amplitude Ict of the cross-track signal, and the modulation factor greatly exceeded 20% as well. That is, even when the concave/convex pattern of BCA was formed with the shape of the emboss pit arrays or of the grooves and the emboss pit arrays in place of the grooves, the same or equivalent effect as that of Example 1 was obtained. On the other hand, in the case of the optical information-recording media of Comparative Examples 8 and 9, the maximum amplitude Ict of the cross-track signal was larger than the minimum amplitude (RH−RL) of the reproduced signal, and the modulation factor was smaller than 20% as well.

As clarified from Table 5, the following results are obtained by making comparison for the values of ΔIp/ΔIo or ΔIo/ΔIp of the optical information-recording media (Example 9 and Comparative Example 8) in which BCA is formed with only the emboss pit arrays. In the case of Example 9 (TP×NA/λ=0.562), the value was not more than 1.4, and the amplitude fluctuation was small. However, in the case of Comparative Example 8 (TP×NA/λ−0.642), the value was larger than 1.4. The following results are obtained by making comparison for the values of ΔIg/ΔIl2 or ΔIl2/ΔIg of the optical information-recording media (Example 10 and Comparative Example 9) in which BCA is formed with the grooves and the emboss pit arrays. In the case of Example 10 (TP×NA/λ=0.562), the value was not more than 1.4, and the amplitude fluctuation was small. However, in the case of Comparative Example 9 (TP×NA/λ=0.642), the value was larger than 1.4. That is, it has been revealed that even when the concave/convex pattern of BCA is formed with the shape of the emboss pit arrays or of the grooves and the emboss pit arrays in place of the grooves, then the amplitude fluctuation of the BCA reproduced signal is decreased as well, and the satisfactory signal quality is obtained, when TP×NA/λ≦0.6 holds, in the same manner as in Example 1.

According to the optical information-recording medium of the present invention, the light-absorbing layer (recording layer composed of the dye material), which has the film thickness of such an extent that the reproduced signal is sufficiently obtained from BCA, can be formed on the substrate of BCA, and the BCA reproduced signal, in which the amplitude fluctuation is extremely small, is obtained even when the BCA information is reproduced without performing any tracking control. Therefore, the optical information-recording medium of the present invention is most suitable, for example, for the optical information-recording medium such as HD DVD-R which is based on such a system that the recording layer is formed of the dye material, and the BCA information is reproduced without performing any tracking.

What is claimed is:

1. An optical information-recording medium provided with a substrate and a light-absorbing layer formed of a dye material on the substrate, the optical information-recording medium comprising:
a user information area in which a concave/convex pattern including spiral-shaped or concentric grooves is formed; and
BCA which is provided on an inner circumferential side of the user information area and in which information is recorded with a bar code, wherein:
a concave/convex pattern, which is different from the concave/convex pattern formed in the user information area, is formed in BCA.

2. The optical information-recording medium according to claim 1, wherein the following relationship holds between a track pitch TP of the concave/convex pattern of BCA and a track pitch TPy of the concave/convex pattern in the user information area:
TP<TPy.

3. The optical information-recording medium according to claim 2, wherein the following relationship holds among the track pitch TP of BCA, a wavelength λ of a reproducing light beam and a numerical aperture NA of an objective lens to be used for reproduction on the optical information-recording medium:
(TP×NA)/λ≦0.6.

4. The optical information-recording medium according to claim 3, wherein the following relationship holds among the track pitch TP of BCA, the wavelength k of the reproducing light beam and the numerical aperture NA of the objective lens to be used for reproduction on the optical information-recording medium:
0.45≦(TP×NA)/λ≦0.6.

5. The optical information-recording medium according to claim 1, wherein the concave/convex pattern of BCA includes grooves, and the following relationship holds among a width LW1 between the grooves of BCA, a wavelength λ of a reproducing light beam and a numerical aperture NA of an objective lens to be used for reproduction on the optical information-recording medium:
(LW1×NA)/λ≦0.3.

6. The optical information-recording medium according to claim 5, wherein the following relationship holds between a track pitch TP of the concave/convex pattern of BCA and a track pitch TPy of the concave/convex pattern in the user information area:
TP<TPy.

7. The optical information-recording medium according to claim 5, wherein the following relationship holds among a track pitch TP of BCA, a wavelength λ of a reproducing light beam and a numerical aperture NA of an objective lens to be used for reproduction on the optical information-recording medium:
(TP×NA)/λ≦0.6.

8. The optical information-recording medium according to claim 5, wherein the following relationship holds among a track pitch TP of BCA, the wavelength λ of the reproducing light beam and the numerical aperture NA of the objective lens to be used for reproduction on the optical information-recording medium:
0.45≦(TP×NA)/λ≦0.6.

9. The optical information-recording medium according to claim 5, wherein the following relationship holds between a minimum amplitude Imin of a reproduced signal obtained when the information of BCA is reproduced without performing any tracking and an amplitude CT of a cross-track signal:
Imin>CT.

10. The optical information-recording medium according to claim 5, wherein a reflectance of a recorded portion of BCA is different from a reflectance of a non-recorded portion of BCA, and the following relationship holds between a higher reflectance RH and a lower reflectance RL:
(RH−RL)/RH≧0.2.

11. The optical information-recording medium according to claim 5, wherein when the information of BCA is reproduced by radiating the reproducing light beam onto BCA without performing any tracking, a first amplitude of a reproduced signal is obtained when a spot center of the reproducing light beam is positioned at a center of a groove of the grooves, and a second amplitude of a reproduced signal is obtained when the spot center of the reproducing light beam is positioned at a center between the grooves, and wherein one of the first and second amplitudes is not less than the other of the first and second amplitudes, and a ratio between one of the first and second amplitudes and the other of the first and second amplitudes is not more than 1.4.

12. The optical information-recording medium according to claim 1, wherein the concave/convex pattern of BCA includes emboss pit arrays, and the following relationship holds among a width LW2 between the emboss pit arrays of BCA, a wavelength λ of a reproducing light beam and a numerical aperture NA of an objective lens to be used for reproduction on the optical information-recording medium:
(LW2×NA)/λ≦0.3.

13. The optical information-recording medium according to claim 12, wherein the following relationship holds between a track pitch TP of the concave/convex pattern of BCA and a track pitch TPy of the concave/convex pattern in the user information area:
TP<TPy.

14. The optical information-recording medium according to claim 12, wherein when the information of BCA is reproduced by radiating the reproducing light beam onto BCA without performing any tracking, a third amplitude of a reproduced signal is obtained when a spot center of the reproducing light beam is positioned at a center of an emboss pit array of the emboss pit arrays, and a fourth amplitude of a reproduced signal is obtained when the spot center of the reproducing light beam is positioned at a center between the emboss pit arrays, and wherein one of the third and fourth amplitudes is not less than the other of the third and fourth amplitudes, and a ratio between one of the third and fourth amplitudes and the other of the third and fourth amplitudes is not more than 1.4.

15. The optical information-recording medium according to claim 1, wherein the concave/convex pattern of BCA includes grooves and emboss pit arrays formed between the grooves, and the following relationship holds among a wider width LW3 of widths between an emboss pit array of the emboss pit arrays and grooves of the grooves disposed on both sides of the emboss pit array, a wavelength λ of a reproducing light beam and a numerical aperture NA of an objective lens to be used for reproduction on the optical information-recording medium:
(LW3×NA)/λ≦0.3.

16. The optical information-recording medium according to claim 15, wherein the following relationship holds between a track pitch TP of the concave/convex pattern of BCA and a track pitch TPy of the concave/convex pattern in the user information area:
TP<TPy.

17. The optical information-recording medium according to claim 15, wherein when the information of BCA is reproduced by radiating the reproducing light beam onto BCA without performing any tracking, a fifth amplitude of a reproduced signal is obtained when a spot center of the reproducing light beam is positioned at a center of a groove of the grooves, and a sixth amplitude of a reproduced signal is obtained when the spot center of the reproducing light beam is positioned at a center between the groove and an emboss pit array of the emboss pit arrays, and wherein one of the fifth and sixth amplitudes is not less than the other of the fifth and sixth amplitudes, and a ratio between one of the fifth and sixth amplitudes and the other of the fifth and sixth amplitudes is not more than 1.4.

18. The optical information-recording medium according to claim 1, wherein information is recorded and reproduced with a blue laser in the user information area of the optical information-recording medium.

19. An optical information-recording medium provided with a substrate and a light-absorbing layer formed of a dye material on the substrate, the optical information-recording medium comprising:
a user information area in which spiral-shaped or concentric grooves are formed; and
BCA which is provided on an inner circumferential side of the user information area and in which information is recorded with a bar code, wherein:
at least one of grooves and emboss pit arrays are formed in BCA, and the following relationship holds between a minimum amplitude Imin of a reproduced signal obtained when the information of BCA is reproduced without performing any tracking and an amplitude CT of a cross-track signal:
Imin>CT.
